(19) United States
(12) Patent Application Publication
(10) Pub. No.: US 2016/0180240 A1
(43) Pub. Date: Jun. 23, 2016

(54) APPARATUS AND METHOD FOR HIGH PERFORMANCE DATA ANALYSIS

(71) Applicant: KYNDI, INC., Redwood City, CA (US)

(72) Inventors: Arun MAJUMDAR, Alexandria, VA (US); James Ryan WELSH, Reston, VA (US)

(73) Assignee: KYNDI, INC., Redwood City, CA (US)

(21) Appl. No.: 14/971,769

(22) Filed: Dec. 16, 2015

Related U.S. Application Data
(60) Provisional application No. 62/092,589, filed on Dec. 16, 2014.

(51) Int. Cl. G06N 7/00; G06Q 30/08

(52) U.S. Cl. CPC G06N 7/005; G06Q 30/08

(57) ABSTRACT

A system that learns by synthesizing completely new data patterns by an economic trading model of hypotheses or evidence as goods to be traded. The system comprises a society of processing modules that collectively interact with one another until steady state equilibrium is reached, in order to solve a given problem.

### CROSS-REFERENCE TO RELATED APPLICATIONS

This application is based upon and claims the benefit of priority to provisional U.S. Application No. 62/092,589, filed Dec. 16, 2014, the entire contents of which are incorporated herein by reference.

### BACKGROUND

1. Field of Disclosure

The present disclosure relates to a system and method of processing and analyzing data. More specifically, embodiments of the present disclosure provide a system and method for producing societies of intelligent software agents for dynamic data analysis.

2. Description of Related Art

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

In recent years, the amount of dynamic data generated from users and their devices has increased exponentially. Accordingly, users tasked with analyzing such data are overwhelmed when using technology designed to process a static data repository. Current methods of computing, including some current Artificial Intelligence (AI) systems, have a difficult time analyzing complex, dynamic data. For instance, neural networks that are based on back propagation algorithms typically encounter the problem of having insufficient processing power that is required to effectively handle the processing of large amounts of data. Additionally, the execution time required by neural networks is often unacceptable by applications that generate and require data processing to be performed in real time. Statistical and parametric techniques that were useful in the past by measuring the relevance of previously identified data patterns simply cannot creatively synthesize, hypothesize, or “imagine” how evidence at hand could fit together into a new unknown pattern or scenario.

Accordingly, there is a requirement for a cognitive computing framework, wherein societies of processing modules collectively form a computing platform such that streams of data, databases, documents, images, and multimedia data in any form can be processed and modeled by the processing modules in order to produce categorization of data, reasoning, and clustering of data for decision making purposes.

### SUMMARY

Aspects of the present disclosure provide for a system that learns by synthesizing completely new data patterns (referred to herein as ‘Gestalts’) within a social and cultural context. The system comprises a society of processing modules (referred to herein as ‘agents’) that collectively interact with one another until steady state equilibrium (e.g. Nash equilibrium) is reached, in order to solve a given problem.

The system, referred to herein as AIT Active Intelligence Traders (AIT) system learns by synthesizing gestalts that can then be used in novel contexts to identify analogous situations in which the original data no longer appears. Accordingly, a user's productivity is greatly enhanced as the AIT system draws analogies from user input and further creates new possibilities, which a single user could not conceive. Furthermore, embodiments of the present disclosure provide for a means to learn from structured and unstructured data using the AIT intelligent software agents that form a robust cognitive model. Moreover, the system can adapt dynamically to complex data using an architecture based on organizational theory, financial portfolio theory, game theory, and other economic models.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

Various embodiments of this disclosure that are proposed as examples will be described in detail with reference to the following figures, wherein like numerals reference like elements, and wherein:

FIG. 1 illustrates an exemplary overview of the system according to one embodiment;

FIG. 2 illustrates an exemplary data filtering operation to form a percept;

FIG. 3 illustrates by one embodiment, a hierarchical architecture of the system;

FIG. 4 depicts an exemplary percept memory model;

FIGS. 5A and 5B illustrate according to one embodiment, a society of agents;

FIG. 6 illustrates according to one embodiment, an exemplary schematic depicting agent interfaces;

FIG. 7 illustrates according to one embodiment, a communication framework between agents to form agent societies;

FIG. 8 illustrates according to one embodiment, a schematic representing an execution cycle of agents; and

FIG. 9 illustrates a block diagram of a computing device according to one embodiment

### DETAILED DESCRIPTION OF EMBODIMENTS

Referring now to the drawings, wherein like reference numerals designate identical or corresponding parts throughout the several views. Accordingly, the foregoing discussion discloses and describes merely exemplary embodiments of the present disclosure. As will be understood by those skilled in the art, the present disclosure may be embodied in other specific forms without departing from the spirit or essential characteristics thereof. Accordingly, the present disclosure is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

By one embodiment of the present disclosure, the AIT system is engineered as a closed-loop, end-to-end system to organize data processing and decision-making software modules, or agents, by interpreting streaming data from a network, e.g. Internet, using a trading model. The AIT system is built using intelligent software agents to control the various data processing and pattern recognition algorithms: the agents are containers for algorithms and agents can group a multiplicity of other agents together. AIT provides at least the following functionalities (1) interpreting data sources and sensing information thereof, (2) synthesizing virtualized information networks from the interpreted data sources, (3) detecting, perceiving and recognizing patterns across any part of the virtualized information networks, (4) relating meanings to detected patterns in terms of analogous prior experience, using the virtual information networks (5) combining evidence, conjecturing, hypothesizing and drawing conclusions on the relevance of findings of interest to a user, and (6) producing recommendations or reporting while continuing learning from operational outputs.

The AIT platform executes a set of intelligent software agents using distributed execution patterns as workflows, expressed in the AIT Algorithm Cycle which governs the overall system behavior. Once implemented, these workflows can be executed at any scale. The framework below shows the software agent components of AIT including:
Workflow templates: these integrate software agents that combine informational and computational algorithms with distributed patterns of search, discovery and analysis;
An inner process AIT Project Manager and Dashboards for reporting; and
A large catalog of algorithms and models for easy plug-n-play use.

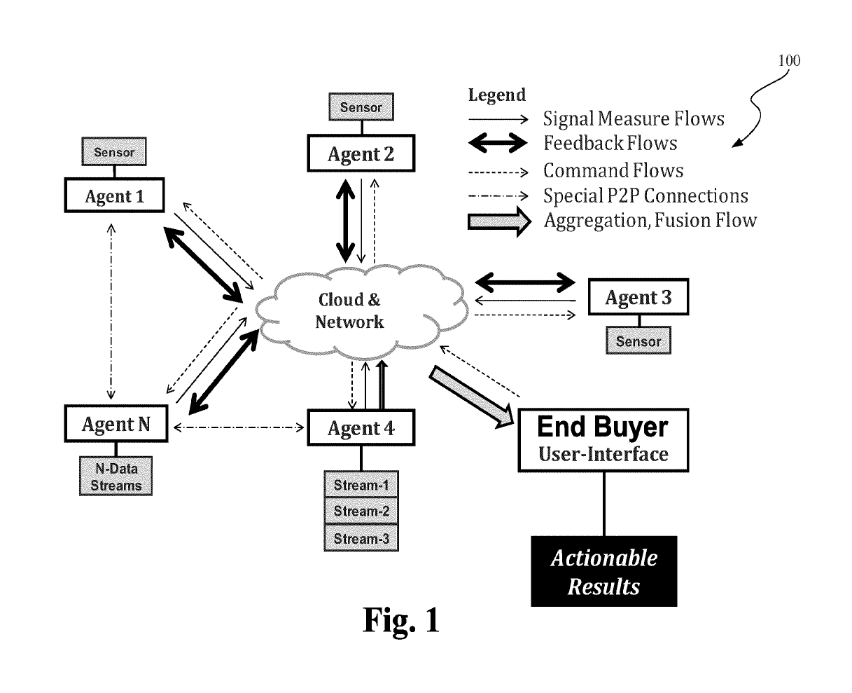

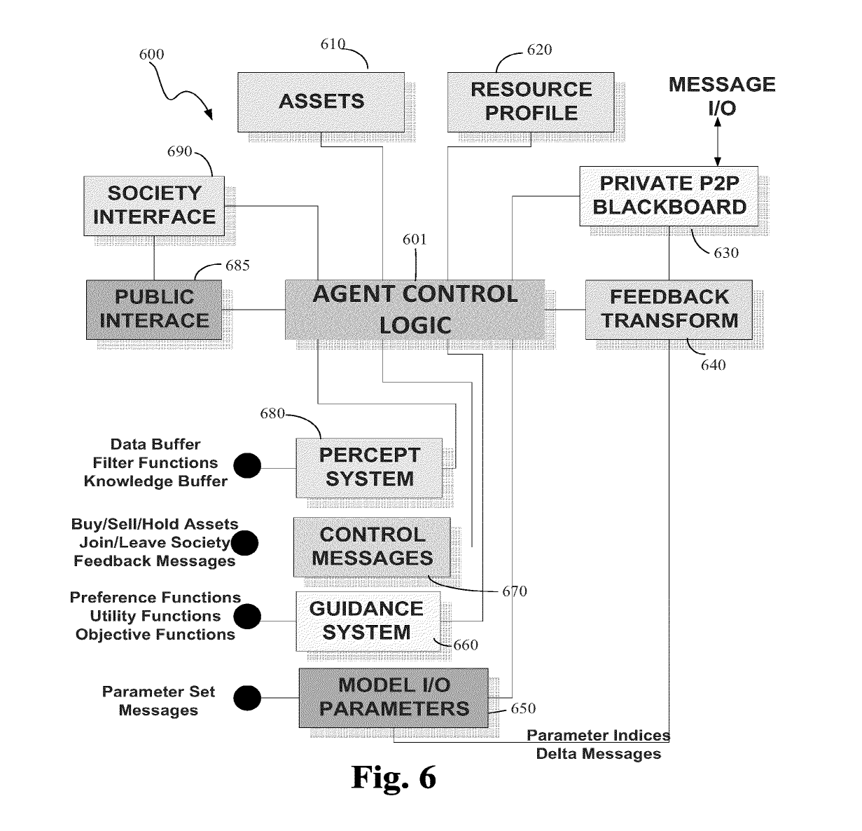

FIG. 1 shows the computational and data resources the AIT platform can handle. As new algorithms evolve for big data processing, AIT agents can encapsulate or contain these algorithms and use them: the purpose of AIT is to be able to create societies of agents that learn from training sets and that then can make recommendations on new data based on the learned data. See FIG. 1 for the overall operation that makes use of control (guidance/feedback) signals (and refer to FIG. 6 for the structure of an individual agent).

In AIT, a software Agent is the basic unit of execution. These Agents are defined to have the following characteristics (See FIG. 6):
Communication blackboards
Asset and consumption profiles
Input and output ports
Parameter information
Feedback and guidance control

AIT processes consist of a workflow that contains a society of intelligent agents: these workflows are cloned/split/rewired to achieve the required distribution topology of the agents. Custom distribution units allow sub-workflows to be distributed in parallel or pipelined and distribution units are standard in AIT, thus enabling users to create their own custom distributions, with varying security requirements, at will.

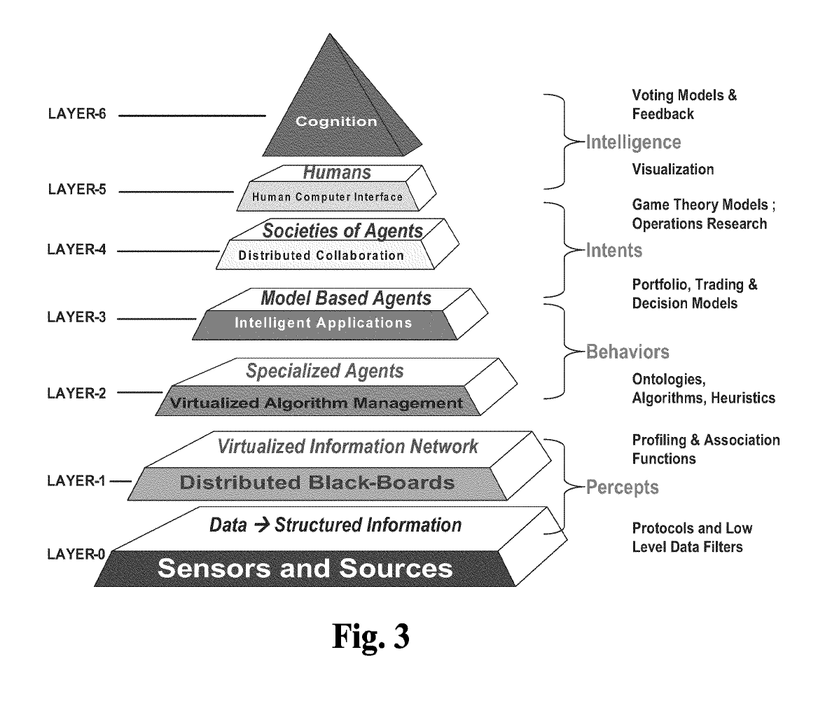

Further, the system is composed of a multi-layer architecture (described later with reference to FIG. 3) with the bottom layer comprising raw data inputs, intermediate sense-making layers, and a top layer for outputs of reports. The intervening levels include intermediate concepts and categories that mediate the transition from raw data into perceptual structures (i.e., gestalts). The process of evidential reasoning occurs by activating a gestalt representation in the top layer by propagating data upwards through filters at the bottom layer, both top-down and bottom-up agents mediate the process.

A top-down agent attempts to fit data from lower layers into gestalt templates at upper layers, while bottom-up agents activate gestalts in upper layers when a pattern is partially detected by lower layers. Several agents can also themselves function as a virtualized information network, referred to herein as a ‘society’, whose role is to connect concepts using the gestalt representation within the same level or between levels. Agents may work forward from user-supplied or conjectured hypotheses to derive new conclusions or backwards to reach a conclusion by assuming that gestalts partially supporting a template conclusion are already true. Additionally, the agents embody machine-learning knowledge, heuristic or background knowledge, extra-evidential factors, and feedback. Accordingly, inputs to AIT can prime the system for processing by pre-activating certain gestalts in the top layer in order to set the initial goals of the software agents. Once the goals are set, the agents may interact as individual economic agents pursuing their private interests, achieving the optimal allocation of finite processing resources and achieving the goal set by user inputs.

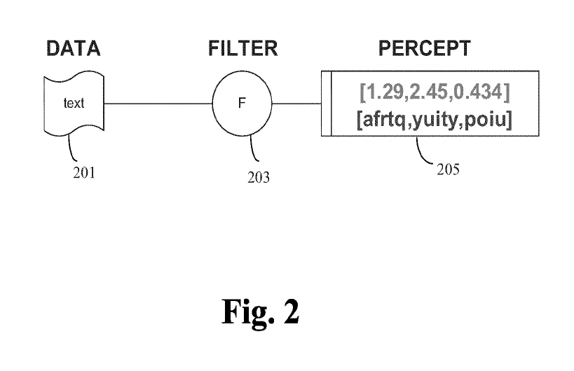

By one embodiment, a goal may be broken apart into a number of queries that the agents must answer, and this process propagates down the hierarchy, activating agents into action, pro-actively seeking “data” from various sources at the lowest levels see AIT-Algorithm-Cycle. The query results are abstracted, fused and propagated upwards as evidential patterns, which are further recognized as higher level patterns. High order patterns can themselves be made up of time or event ordered meta-data in the form of plans (i.e. plan fragments) that can represent any time series of data and its related outcomes (i.e. observables) such as structural patterns of malware, or conversational patterns of negotiation, argumentation or stock-market patterns in the buy-sell-hold behaviors of market actors. These input pattern structures result from the lower level percepts and query answering processes that generate high level pattern structures which are converted, by the present invention, into high-level cognitive representations as they are propagated up the hierarchy of levels of agents. For instance, FIG. 2 illustrates according to one embodiment, a percept 205 formed by an agent based on filtering 203 of raw textual data 201. Specifically, as shown in FIG. 2, the value ‘1.29’ is associated to the value ‘afrtq’. The cognitive representations in the higher layers are referred to herein as a ‘percepts’, which are aggregated into gestalts, thereby forming a kind of semantic field-like data representation.

The AIT Algorithm Cycle is based on several steps where the agents evolve economically from their initial randomized states into highly organized states that can be stored as a “snapshot” or graph of the AIT agents and recalled for re-use in pattern recognition or as models of complex patterns to be recognized in data. It must be appreciated that economics is relevant in the guidance, control, and organization of agents and societies of agents.

At the heart of economics is constrained optimization. For example, a household's consumption is constrained by its available income. Or, in the case of the AIT system, an agent's consumption of processor time or hypotheses is constrained by its assets. The prototype problem in economics is:
maximize ƒ(x₁, . . . , xₙ)
   where (x₁, . . . , xₙ)εRⁿ must satisfy
g₁(x₁, . . . , xₙ≦b₁, . . . , gₖ(x₁, . . . , xₙ)≦bₖ,
h₁(x₁, . . . , xₙ=c₁, . . . , hₘ(x₁, . . . , xₙ)=Cₘ.
   The function ƒ is an objective function, while g₁, . . . , gₖ and h₁, . . . , hₘ are constraint functions. One important economic example of a constrained optimization problem is the Utility Maximization Problem.

In the simple two-dimensional model of consumer choice, consumers only have two goods to choose from, x₁ and x₂. The pair (x₁, x₂) represents a choice of an amount for both goods and is called a “commodity bundle.” The set of all possible commodity bundles can be represented geometrically in a plane, or “commodity space.” Consumers have preferences about commodity bundles in commodity space. That is, in this example, given any two commodity bundles, the consumer either prefers one bundle to the other or is indifferent between the two. If the consumer's preferences satisfy some consistency hypotheses, the commodity bundles can be represented by a utility function and assigned a real number. This representation of consumer preferences is used to describe the consumer's choice. For example, suppose a consumer is confronted with a set B of commodity bundles and is asked to choose among them. The consumer will choose so as to maximize his or her utility function on the set B. Thus, the economic problem of modeling consumer choice is reduced to a mathematical problem of maximizing a given function on a given set. That is, given some consistency hypothesis of utility maximization, consumer preferences can be represented by a utility function, which is one economic example of an objective function.

With this in mind, the AIT Algorithm Cycle shown is as per the following steps:

Step-1 initialization of AIT, random agent populations are created with a starting amount of virtual currency, called their “asset” and a consumption profile (how many units of virtual currency it takes to use processor time and memory). Refer to FIG. 6 for the specific embodiment of an agent.

Step-2 the user provides the agents with a specific goal by providing an example input data and a target output response (or result) as well as an offer of payment in virtual currency units. Agents individually contain algorithms, as discussed later in this patent, that calculate evidential signal measures on their specific input data sources, which they use to generate a single percept or a collection of “percepts” that in aggregate form represent a “perception”. These perceptions are computer representations of the transformed user input data and transformed user input results that relate to the data so as to form a training pair for the AIT system and are discussed further in Table 1 later in this patent.

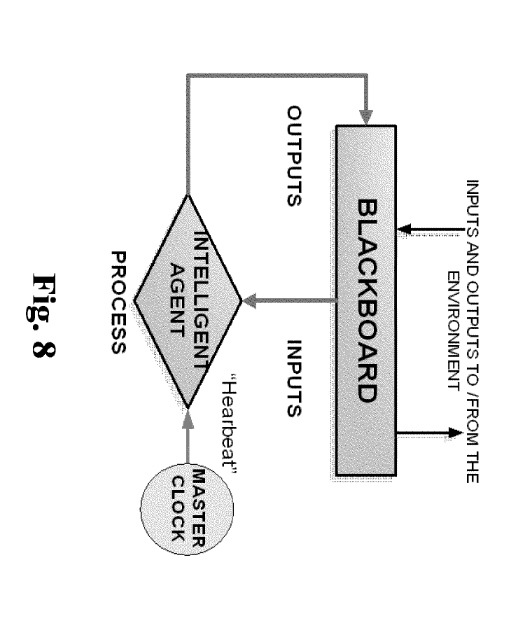

Step-3 The agents respond to the request by randomly dividing into two populations called Buyers and Sellers. The buyers represent the desired output result and the sellers represent the input data. Sellers sell hypotheses based on their internal algorithms or by team forming with other agents to produce more complex offers (of hypotheses) for Buyers. Both Sellers and Buyers can chose to hold their individual positions for a computation cycle (as described later in this patent per FIG. 8 as a hearbeat clock).

Step-4 Seller Agents process their input data to produce output data and can also interact amongst each other to produce a result hypothesis. If a result hypothesis is close to the true result, as measured accordingly by the Buyer, then the Buyer agents will pay the sellers by stating a maximum value, and then paying partially on that maximum value (if the result is not exact), to indicate the sellers are close to the true result or will decline to pay, which tells the Sellers that their results have no value.

Step-5 When the number of Seller agents declines, new Agents are randomly added such that each added agent contains an algorithm for data processing as well as initialized (randomized) tuning parameters to tune the algorithm parameters. This ensures that the system evolves in a manner similar to traditional genetic algorithms except that in the case of the present invention, instead of evolving bit-strings, it is agent profitability and societies that are evolved.

Step-6 Several Seller-Agent can combine into societies to produce a more complex data transformation process by the methods in the present patent and these configurations, when they are sufficiently profitable according to a user set threshold, they can be stored and recalled as needed. Sellers can join or leave societies and some Sellers can become intermediary Buyers if the purchased hypotheses or data serve to improve their own output results.

Step-7 The society reaches a steady state when there is a minimum society of buyers and sellers and the maximum payment is reached. At this point, no seller is incentivized to change its decision position with respect to other sellers, societies or buyers and an equilibrium (e.g. Nash Equilibrium—other types of equilibrium could also be used) is reached signaling the end of the computation.

The user can, at any time, help the societies of agents in AIT by providing relevant evidential signal schemata and related measures to the pool of agents, for example, from a database management system (DBMS), or that that includes other agents, algorithms, and schemata.

Within the AIT system, perceptions are acted on by the agents using a diversity of algorithms: that is, they synthesize a working hypothesis by using an evolving combination of deductive, inductive or abductive reasoning that seeks to explain the “meaning” of what is being perceived by combining background knowledge, data and which includes heuristics, to produce societies of agents that evolve and form stable pattern recognition groups once the steady state equilibrium is reached.

Once a hypothesis is formulated, by an agent, it can be offered for sale in the pool of hypotheses which can include user input and/or economic models to assess the plausibility of the hypotheses and, thus, the “survivability” of the agent providing the hypothesis. Agents survive as long as they maintain an account of virtual currency which is provided by a Buyer buying what the selling agent is offering either individually or in a group. It must be appreciated that during the execution the steps, the evolution of agents is governed by their ability to be profitable and hence is an economic model (described later), where agents singly or in groups can trade evidence and hypotheses, and auction off their results, similar to an economic market. Feedback and other signal measures from a prior learning process alter the selection of plausible hypotheses.

Turning now to FIG. 3 is illustrated by one embodiment, a hierarchical architecture of the AIT system. As shown in FIG. 3, the architecture is composed of seven hierarchical aspects: (1) Layer 0: raw data inputs and sources that use very simple algorithms and agents to provide simply structured information (e.g. meta-data) from raw input data, (2) Layer 1: distributed and networked shared memory spaces, such as tuples or Linda-Blackboards that provide a virtualized information access network, (3) Layer 2: virtualized algorithm management that use specialized agents as containers of algorithms, (4) Layer 3: intelligent applications composed using various workflows that assemble algorithms together, (5) Layer 4: models encapsulated in agents and societies of agents to enable distributed collaboration between the intelligent applications, (6) Layer 5: a human computer interface layer for user interaction, and (7) Layer 6: a cognitive layer for creation of recommendations or reports.

The first two layers deliver “percepts” which provide the system with a perception capability of the data. The second pair of layers, i.e., virtualized algorithm management and intelligent applications, provides the behavior recognition capabilities, while the third pair of layers provides the context of plausible scenarios that can explain the behaviors in terms of intents. The last levels deliver the intelligence capability by fusion of scenarios into a report. In what follows is provided a description of each layer of the architecture as illustrated in FIG. 3.

The layer 0 transforms data into structured information. Specifically, sources provide access to raw data and sensors provide immediate low-level data filtering. Source agents provide the specific technology to interoperate among databases and other data sources. By one embodiment, the source agent converts data from the data source into a variable length Unicode string of characters sample, delimited by the protocol conventions. Sensor agents work with sources to transform the Unicode data into structured message packets. The message packets are annotated with very basic metadata.

In layer 1 (i.e., distributed blackboards) the received message packets are given to a special agent that implements a distributed working memory (‘Blackboard’). Several agents at this level play the role of multiple messaging blackboards that other agents can visit and read. Collectively, the blackboards create a virtualized information network that enables seamless access between layers of agents. Additionally, it decouples where agents process data versus where data is collected. Several other blackboards, private to the agents, permit inter-agent messaging and enable groups of agents to communicate with each other. This layer of the architecture is a crosscutting function to all other layers and systems and plays roles varying from a routing system to a low-level associative data store.

In layer 2 of the architecture, algorithms are dynamically loaded from a pool of algorithms. Each agent is made up of a basic loader-program that can load algorithms, other agents, or even societies of agents for specific types of data processing. The agents are characterized by the diversity of different algorithms that they can load as well as the diversity of combinations of agents of algorithms. By sensing the flows of information on blackboards, the agents can act on either the flows or the information on the blackboards to provide a wide variety of association and correlation capabilities.

Further, the intelligent application layer (layer 3) is composed of a set of agents and algorithms that work together to deliver a capability. The intelligent-applications are assembled from workflows by agents using various models by calling and connecting the lower level agent algorithms into “societies” that then delivers the required functionality. The workflows themselves are assembled using an economic model to allocate model-components, enabling agents to create and work in societies based on the satisfaction of needs according to utility, preference, and objective functions in a virtual economy.

In the distributed collaboration layer (layer 4), several intelligent applications may collaborate and/or coordinate with the goals of the user. In addition, the collaboration must optimize the value of results, as well as the use of computational resources. Game theory and operations research models are used where expected payoffs and expected utility lead to revision of hypotheses, as well as multiple point of view and possible new insights delivered to the user at the next layer. Agents treat outputs of applications and the messages on the blackboards as inputs from which to synthesize new models composing several intelligent applications to hypothesize intents.

The human computer interface (layer 5) combines several societies of agents together using economic and financial models to optimize delivery of coherent information and hypotheses. According to one embodiment, the human computer interface may be comprised of a Controlled English natural language agent, a visualization agent and a simple dashboard agent with panels and control buttons or other visual interaction elements for the user to reward the system (by making available virtual currency) or punish the system (by declining to pay). Taking into account user inputs as feedback, the AIT system acts on the feedback by distributing virtual currency to the agents or reducing the flow of currency which forces agent reorganization. The agents are able to produce system logs of their steady state as they process data which provides cognitively plausible explanation generation capability to the user explaining which algorithms and why or how a result was achieved.

The user can also simply provide a starting point so that agents can be dispatched onto the data source. User input is automatically elaborated by the system into patterns, which the system then uses to seek actionable information that extends beyond the original concept of the user, and thus has value of producing new information. User feedback also enables the system to learn and use the experience or training from feedback in its activities.

At the highest level (layer 6), the human computer interface renders all other low level models into outputs such as reports, or in visual form as activities or scenarios sensed for identifying relevant information. With the goal having been provided by the user, the AIT system carries out semi-automated knowledge-fusion and information synthesis. The AIT system may indicate to the user information that traditional methods may have missed entirely, or found non-obvious connections.

Additionally, the architecture of FIG. 3 also provides for the interoperability between layers using a simple ‘input, process, and output’ functional model. Specifically, each layer of the architecture has several qualities, such as, the ‘Level’ at which the architecture addresses its inputs; the ‘Typology’ of what the architecture serves functionally; the ‘Operation’ which describes what the architecture is doing at each level; and the ‘Purpose’ which is the intended output result that the architecture at that level will generate for other levels to process, possibly with feedback that has been propagated between levels.

The percepts as individual components of perceptions can include both lexical and numerical valuations of raw input data. The two views can be combined into a single gestalt representation structure, referred to herein as a ‘semantic atom’, which captures the notion of a datum and its percept. In other words, the semantic atom is a software data structure for an agent that captures relationship between data and the perception of its meaning in terms of interpretation functions. Accordingly, by developing a two level design provides the present disclosure the advantageous ability that, while every data element is language dependent, every percept element is language independent, and therefore, usable across all languages.

Accordingly, by using ‘profiles’ of the semantic atoms, the AIT system can recognize subtle or sudden changes in behavior in the data source. Behaviors are sequences of gestalts and their changes over time constitute gestalt patterns. Thus, by computing a time-series function on the primitive gestalts, behavior can be represented.

Furthermore, ‘intents’ are the set of behaviors, and relationships between behaviors, that correlate by being systematic, coherent and cohesive and are considered to be related to underlying causal forces: intents. Therefore, by one embodiment, a representation of intent begins as a ‘schema of profiles’, which is refined into a working hypothesis by checking consistency and systematicity of the profile semantic labels. The schema structure is a graph whose nodes are profiles and edges are requirements and whose faces are correlations and explanations. Reasoning processes prune out useless schemata by using background knowledge based on learned profiles or ontologies. Evidence assessment functions select the best schemata as the working hypotheses to be passed on for further consideration based on mounting evidence.

The systems goal is to generate a recommendation or report for the user. At the top-level, the structure that generates the user's recommendation and tasks the agents is a Gestalt-Decision Representation (GDR): a “story” outline (from a library of Gestalt “plots” and “themes”) to be filled in with details, sources of data, the actors, and the scenarios of interpretation as well as the confidence levels in the users language.

Once a user receives a report, feedback from the user to the system is used to tune its performance, learn, or revise its findings. User feedback to the report can trigger significant re-evaluations of current assessments and this process can force many agents to review the plausibility of their hypotheses, evidence and the facts. At one extreme, the story structure itself can be revised. The re-evaluation process of hypotheses and scenarios begins by drilling back down to the facts or requesting new fact-gathering agents. At the other extreme, the societies of agents can evolve into patterns that confirm or disconfirm evidence from data.

It must be appreciated that users are typically interested in flexible recommendations that are based on sound hypotheses that are consistent, coherent and plausible as a whole story. Therefore, reviewing the facts from multiple points of view is a key enabler to this process: hence, the system uses a library of gestalt scenario-representations to provide the multiple viewpoints. Scenario representations are pieces of a whole story: perhaps not the entire story (although this is not precluded). These scenarios can combine into larger fragments. Scenario representations can drive the system in feedback to gather more data.

Once facts have been gathered, heuristics and models can be used to connect them into a use-case that fits the scenario. A use-case is also a gestalt to goal and result-representation built by marshaling evidence, from behaviors and facts in the context of a scenario or to multiple scenarios: the model expresses result recognition as a gestalt representation structure. This is performed by using a file containing an “example” situation containing a “result” within the context of a goal or intended outcome. These situation, result and goal example structures originate from human heuristics and knowledge of human behaviors or via labeled examples from a training set and the evolutionary economic training process described in the algorithm of the AIT system. Once agents are trained to perceive an intent representation use-case (and these are stored in the Agents' DBMS), they can view multiple data streams using the use-case or add to it using further learned knowledge, via user feedback, as their “experience” (i.e., their success or failure of hypotheses formed by connecting schemata).

Building hypotheses regarding goals and situations depends on a library of models to process data into gestalt result-representations. These consist of patterns or actor behaviors, agent behaviors and functions mapped from data inputs. Behavioral models represent the dynamics of relationship and hence time-series functions are used to characterize them.

At the lowest level, the system maps agents, the raw data, and the properties of these data and agents using various functions and meta-data into the gestalt percept-representation. The behaviors of the agents correlate to changes in the perceptions and this represents a “profile” or history of the agents' perceptual experiences interacting with the data. These dynamical interaction patterns, between agent and data, serve as a source to higher-level perceptions, between agents and agents, for association methods to relate these to underlying causes and therefore are implemented using the gestalt representations.

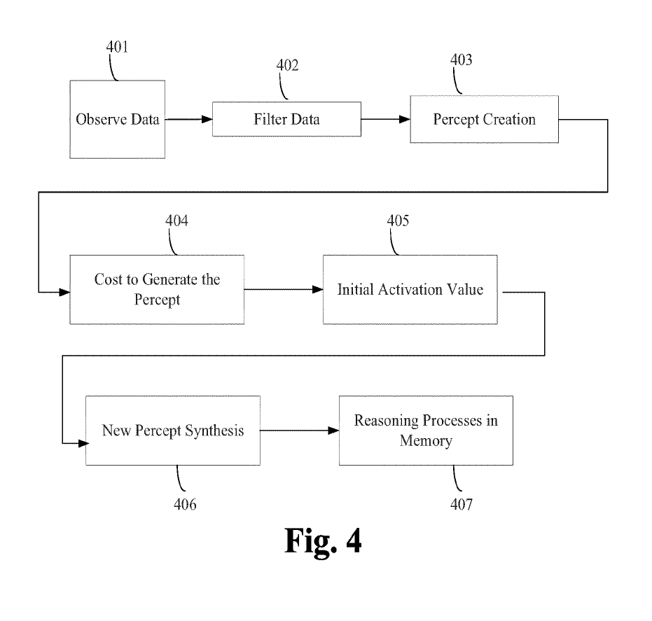

Turning now to FIG. 4 is depicted according to one embodiment of the present disclosure, an exemplary percept memory model.

The first step in the process flow as outlined in FIG. 4 is transduction of data (from the outside world) into a percept and further reification into an information model (i.e., the semantic atom of the agent). It must be appreciated that the provenance of the semantic atom, as well as the current state of bias-parameters of an agent (i.e., a degree to which agent activates the percepts) are both relevant factors for mapping data into percepts. These two factors influence the strength with which an agent ends up confirming or disconfirming its observations, making deductions, or forming hypotheses. As shown in FIG. 4, data observed (401) by an agent is processed by the agent's associated function(s) and further filtered (402) to generate a percept of the data (403). In generating the percept 403, a cost (404) is incurred by the agent, which reflects the amount of computing resources (and computing operations) required by the agent in order to generate the percept.

Each agent maintains within its semantic atom, a state that reflects the agent's percept activation. Specifically, activation of the percept is defined herein as the ease with which the agent can retrieve the percept from a ranked memory wherein the percept is stored (405). Based on the state maintained by the semantic atom, the agent can interpret with confidence an anticipated or apprehensive state that the percept may take in the cycle of percept iteration. The anticipated and/or apprehensive state may be computed based on an anticipation and apprehension operator. Accordingly, due to such operators, it must be appreciated that each agent (even in a community of agents of the same class) may hold differing views of the same data. Furthermore, by one embodiment, the strength of anticipation of the percept is a function of the strength of the percept via its activation level (also referred to herein as ‘percept potentiation’) and the persistence of the semantic atom over time.

Furthermore, combinations of percepts and semantic atom operations can yield new anticipatory states. By one embodiment, the certainty of anticipations decays over time and expectancy ceases to exist when its certainty becomes equal to zero. Anticipatory and apprehensive values may be combined along with the agent's biasing functions. Due to the possibility of multiple situations, agents may use, for instance, a conditional if-then logic, a reasoning based logic, and the like to form a new percept. Note that each percept formed by the agent has an associated decay parameter, as if the percept is not used over time, it eventually decays and ceases to exist. In a similar manner, each percept has a refresh parameter that corresponds to the longevity of the percept. Specifically, when the decay and refresh match, the semantic atom persists. In contrast, when the refresh parameter outgrows the decay, then the semantic atom duplicates (i.e. it splits into two clones like cell mitosis), and if the decay parameter value dominates, the semantic atom ceases to exist.

By one embodiment, there is a cost associated to retrieve a percept formed by an agent. The cost to retrieve a percept depends on its potentiation value, i.e., a degree to which it is ranked as easy to retrieve from (usually long term) memory. Accordingly, potentiation can be visualized as energy (i.e., higher the energy within a context, for a given percept, the easier it is for the percept to be recalled in the given context). Furthermore, in the selection and evolving process of agents (described later) to address a specific task goal, a threshold is required which denotes the minimal potentiation that a percept should have in order to be rapidly retrievable. Note that the threshold may be based per mission and/or task, and that the cost of retrieving a complex percept composition is equal to the summation of the retrieval costs of all retrievable percepts.

According to one embodiment of the present disclosure, there are two kinds of percepts: a basic percept and a complex percept. Basic as well as complex percepts have an initial activation value that is generated once only, when the percept is first created. A complex percept may be assigned an activation value that is the sum of activation values of basic percepts that are fused to obtain the complex percept. Furthermore, percepts may be created or composed in an active working memory (WM) or they are retrieved from a DB into WM. When percepts are created in working memory, they originate from either real world sensor data, or from the internal imagination (abductions) or deductions of the agent's percept interpreter, which uses a library of schemata to compose various new percepts.

Additionally, a complex percept is composed by a formation rule. The formation rule accepts input percepts and carries out information fusion to produce a complex percept (406). The input percepts (to form a complex percept) may be basic percepts, as well as other complex percepts. The activation value of a newly formed percept may be determined by a salience parameter of the percept. The salience parameter reflects how relevant the data of the precept is with respect to the task under consideration and the amount of profit incurred by the agent in trading (i.e., sharing) the percept with other agents.

Further, the newly formed percepts perform a reasoning process (407) to determine the validity and applicability of the generated percept with regard to the task under consideration. Specifically, as described previously with reference to AIT-Algorithm-Cycle (step 6), the agent utilizes reasoning processes such as deductive reasoning and the like to synthesize/revise the percepts in order to test the formed hypotheses or confirm the agent's deductions.

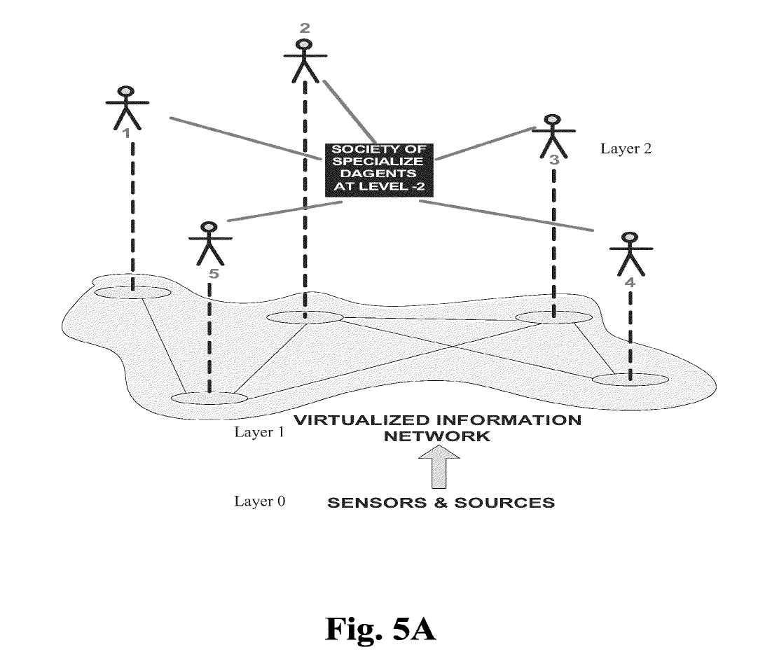

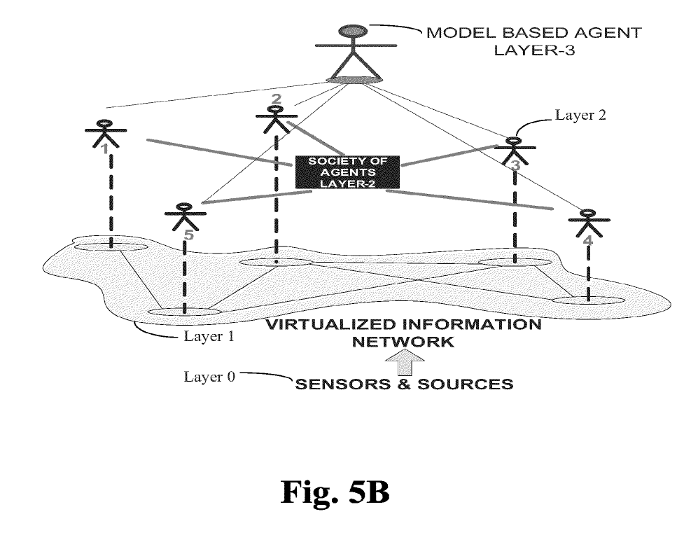

In what follows, is provided a detailed description with reference to FIGS. 5A and 5B illustrating interactions between models to form a society of agents.

FIG. 5A depicts a non-limiting example illustrating a society formation of five specialized agents. By one embodiment, a society is a grouping of specialized agents that act as an ensemble classifier, thereby providing percepts on underlying virtualized information networks that have been provided by the interaction between Layer-0 (sources) and Layer-1 agents (information virtualization).

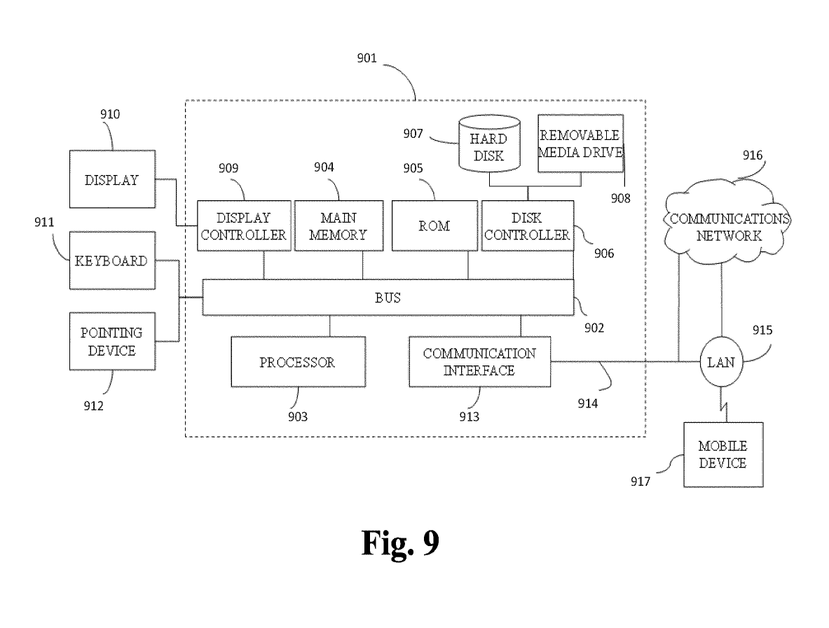

Accordingly, an agent can discover which society of lower-level agents performs best with respect to a particular problem under consideration. By one embodiment, an agent implements a reward and punishment mechanism (described later) of its lower level to generate new variants through parameter variation (as stated previously with respect to guidance system of FIG. 9) or generate new models through an algorithmic social change.

Further, societies of agents average out any individual biases introduced by their individual fixed, shared functional forms or models. In other words, the biases are averaged out because the agents are in a society. Social groups of agents can develop over time at Layer-2 and driven by perceptual cognizers of different patterns at Layer-3. Accordingly, models can compete and arrive at different predictions from the same available data (referred to herein as market data), due to contextual shifts in what is important to perceive (via feedback).

For instance, as shown in FIG. 5A, a society of five specialized algorithm containing agents at Layer-2 (labeled 1-5) generate percepts on the lower level network of structured data elements. Each of these five agents outputs a semantic atom that represents its internal cognitive perception of the data (i.e. the semantic atom operates like a data filter).

Each of the five agents (1-5) comprises a percept generating function internally. Thus, the society as depicted in FIG. 5A generates a 5-percept stream chunk per execution cycle. For sake of simplicity, assume each agent (1-5) is notated as a1, a2, a3, a4, and a5, and that each agent generates its percept by using its own internal algorithms and functions over its input domain (Ω). Specifically, consider that the functions used by the agents are denoted as: a1=ƒ(Ω); a2=h(Ω); a3=g(Ω); a4=s(Ω); and a5=t(Ω), respectively.

Now referring to FIG. 5B, the Layer-3 agent aggregates the society outputs into its own internal percept structure, thus producing its own semantic atom structure and it iterates the same process. As stated previously, the semantic atom contains a collection of complex percepts that represent a field-like structure referred to herein as gestalt. It must be appreciated that each semantic atom has a unique identity, for example, semantic atom ID=‘5123243’. Accordingly, the semantic atom of the Layer 3 agent can be represented as: semantic atom ‘5123243’=[a1:ƒ(Ω), a2:h(Ω), a3:g(Ω), a4:s(Ω), a5:t(Ω)].

Note that each of the percept generating functions, ƒ(Ω), h(Ω), g(Ω), s(Ω), t(Ω) outputs their percepts which also have a structure. For example, the structures (shown to 3 significant decimal places) can be expressed as shown in Table I:

TABLE I
Structures of percepts generated by the five agents of FIG. 5B.

| | |
|---|---|
| f(Ω) = | [0.593, 0.559, 0.012, 0.3442, 0.987, 0.153] |
| h(Ω) = | [0.167, 0.679, 0.22, 0.777] |
| g(Ω) = | [0.844, 0.49, 0.72, 0.62, 0.987] |
| s(Ω) = | [0.034, 0.97, 0.333] |
| t(Ω) = | [0.924, 0.83, 0.1, 0.323, 0.987, 0.153, 0.233] |

The agent at Layer-3 (FIG. 5B) can generate several alternative gestalts internally by applying filter operations. In what follows, sample gestalts created by the agent at Layer 3 are described. Specifically, considering the application of either a primitive list truncation operation, or a primitive list padding operation, having the parameters truncation operation parameter set to 1 and padding parameter set to 0, the new percept generated by the Layer-3 agent is as shown below in Table II:

TABLE II
percept generated by Layer 3 agent for truncation parameter = 1

| | |
|---|---|
| f(Ω) = | [0.593] |
| h(Ω) = | [0.167] |
| g(Ω) = | [0.844] |
| s(Ω) = | [0.034] |
| t(Ω) = | [0.924] |

By one embodiment, the values as depicted in Table II can be further individually processed by implementing a threshold filter for each individual function in order to produce, for instance a binary output. For example, implementing a randomized array of filter thresholds: [0.5, 0, 1, 0.5, 0.75], with an operation that if ƒ(Ω) is greater than 0.5, then output is a binary ‘1’, the values of percept of Table II will generate a binary vector: [1, 1, 0, 0, 1] as shown below in Table III.

TABLE III
Output gestalt as a binary vector

| | | |
|---|---|---|
| f(Ω) | = [0.593] > [0.5] | → [1] |
| h(Ω) | = [0.167] > [0.0] | → [1] |
| g(Ω) | = [0.844] > [1.0] | → [0] |
| s(Ω) | = [0.034] > [0.5] | → [0] |
| t(Ω) | = [0.924] > [0.75] | → [1] |

Accordingly, by varying the parameter set of the filter, one can change the vector outputs. Alternatively, by providing a target bit vector, one can solve for, and create a parameter filter set.

Additionally, such agent processing may be applicable in a diverse range of applications. For instance, the vector can be interpreted as a 1-dimensional image. The vector, [1, 1, 0, 0, 1], is a bit vector of length K=5, and hence the agent can perceive 2^{̂5} states (i.e. 32 states) of the underlying system by using learned or recognized or trained patterns. Accordingly, the gestalt representation computed by each agent may be utilized for image processing problems. Alternatively, as another example, the vector can be used as an index to a set of model functions that represent a linear combination of basis functions in order to generate what would now be the formal continuous gestalt representation. For example, the first bit being ‘1’ would correspond to a function #1 being activated (i.e. that it is selected to be active in a linear combination of functions corresponding to the n-bits of the binary vector). Furthermore, the gestalt representations are highly robust to noise variations in the underlying data sets.

According to one embodiment of the present disclosure, the gestalt representations can be applied in a complex problem space. For instance, consider the percepts generated by the five agents as depicted in Table I. By changing the truncation operation parameter to four and the padding operation parameter to four, the new percept as illustrated in Table IV is generated.

TABLE IV
Structures of percepts generated by the five agents of FIG. 5B,
for truncation and padding parameters set to 4.

| | |
|---|---|
| f_{4,4} (Ω) = | [0.593, 0.559, 0.012, 0.3442] |
| h_{4,4} (Ω) = | [0.167, 0.679, 0.22, 0.777] |
| g_{4,4} (Ω) = | [0.844, 0.49, 0.72, 0.62] |
| s_{4,4} (Ω) = | [0.034, 0.97, 0.333, 0.0] |
| t_{4,4} (Ω) = | [0.924, 0.83, 0.1, 0.323] |

By one embodiment, a filter set as stated previously may be applied to the generated percepts of Table IV. Alternatively, a different filter for each agent may also be applied. For instance, applying the following unique filters as shown in Table V, the gestalt representation as depicted in Table VI is obtained.

TABLE V
Unique filters for each agent

Φ_{f=} [0.5, 0, 1, 0.25]
Φₕ₌ [0, 0, 0.25, 0.25]
Φ_{g=} [0, 0, 0, 0]
Φₛ₌ [0, 0, 0, 0]
Φₜ₌ [0, 0, 0, 0.5]

TABLE VI
Output percepts generated for filters of Table V

Φ_{f} (f_{4,4}(Ω)) → [1, 1, 0, 1]
Φₕ (h_{4,4}(Ω)) → [1, 1, 0, 1]
Φ_{g} (g_{4,4}(Ω)) → [1, 1, 1, 1]
Φₛ (s_{4,4}(Ω)) → [1, 1, 1, 0]
Φₜ (t_{4,4}(Ω)) → [1, 1, 1, 0]

The resultant output as depicted in Table VI is a binary matrix representing the gestalt pattern of the filtered inputs. The matrix can be perceived directly, as either a 2-dimensional binary image or, as in the previous example, the bit positions can represent a combination of functions. For example, the original unfiltered, normalized inputs can function as coefficients of the linear combinations of functions, activated by their respective bit mappings, to provide a weighted manifold (if the functions are projections in an n-space).

Additionally, according to one embodiment of the present disclosure, a meaning has to be assigned to the gestalts created by the agents. For instance, considering the gestalt illustrated in Table I, each domain Ω of the filter function can be assigned a corresponding ‘meaning-making function’ based on a meaning filter criterion, m, and a conjecture selecting function, c. For instance, considering the meaning making function to be m=[0.5, 1, 1, 1, 0, 0], and the conjecture operation to be ‘less than’ operation (<), the output of the function of the first agent is: ƒ(Ω)=[0.593, 0.559, 0.012, 0.3442, 0.987, 0.153]→[1,0,0,0,1,1]. Suppose, the vector [1, 0, 0, 0, 1, 1] is set (by the programmer or learned as) “two people are in dialog”, then that is set as the meaning of the vector.

FIG. 6 illustrates according to one embodiment, an exemplary schematic 600 depicting agent interfaces. Specifically, FIG. 6 depicts the interaction of an agent control logic 601 (implemented by circuitry and described later with reference to FIG. 9) with a plurality of interfaces to control the operation of the agent. The AIT system is composed of many possible agents, processes, heuristics, rules, and models than the time and processor constraints allow to be executed for analytical needs. Accordingly, decisions are required to be made on how to optimally allocate finite processing resources to optimize intelligence processing activities.

Referring to FIG. 6 and by one embodiment of the present disclosure, the AIT system is built using a market metaphor to enable the societies of agents to self-tune their consumption of computing resources (stored in resource profile 620) towards the optimization of quality information with respect to scale or inputs. In effect, the agents form a society (as described previously with reference to FIGS. 5A and 5B) whose structure evolves to achieve a general equilibrium resulting in the best output reports.

The AIT system includes a number of agents and each agent is allocated an initial starting fund (virtual currency) at its creation. The amount of available virtual currency at any given time instant is stored as assets 610. The agent is responsible for allocating in form of bids, for processor time or hypothesis acquisition. Specifically, the agent has to utilize his assets (i.e., virtual currency) in order to acquire processor time and/or acquire a hypothesis. When an agent is paid for its work, its output is found to be useful or is consumed by other agents. The agent could use its currency for other activities but may not get paid, and thereby eventually die out. Agents with a zero account balance for several time periods are killed off.

For each event and each possible action, the agent has a real-valued measure that controls its intention force for achieving a particular state. Specifically, a guidance system 660 that includes (1) preference functions, (2) utility functions, and (3) objective functions, enable the agent to reach a particular intended state. The adherence to intention by an agent is driven primarily by its utility function, which measures the relevance of its inferred associations (hypotheses formed) between a goal context (i.e., what is being sought) and the perception inputs (i.e., the gestalts generated by its semantic atom). A given perception will be considered relevant if its semantic atom output generates values whose measure is over a threshold value. Therefore, pattern recognition in AIT is equivalent to building percept association patterns for which is itself equivalent to associating patterns of agents.

An association of agents is a society within a pattern of communications and capabilities, and is therefore not defined by logical rationality, but by non-linear effects of the sets of percepts that collectively recognizes the patterns of interest. Although the utility function quantifying the value of percepts is not part of the decision theory of the agent or the society, it is still up to the agent to apply its intention in specifying a definition of goals and alternatives. Therefore, preference functions come into play to that effect.

Furthermore, the ability of the agent to compose decisions and make choices is delivered by its preference function (included in the guided system 660), which ranks the choices of rules or other decision-theoretic apparatus it has in determining the output. Lastly, an objective function may alter the utility or preference functions.

The percept system 680 corresponds to the data that a particular agent analyzes and generates a percept based on an associated filter function. By associating one percept with one agent, therefore, combination of percepts comes down to combinations of agents, which reduce to data-filtering criteria as the constraint to multi-agent composition in the sense of an economically efficient society. It is not known, a priori, what the optimal combination and efficiency will be so the effects of utilities and preferences are mapped to a dynamic society in coordination and composition model based on a set of simple rules and heuristics.

The agents have individual rationality but do not receive any direct payoff as a result of the group's performance and hence are loosely coupled to other agents or groups. Within the society, each agent has its own utility function that it maximizes, and therefore, usually will increase its coupling to its source agent. To do so, it takes into consideration the benefits it has of joining a society, versus remaining alone, and/or forging new associations. Agents join and create associations (block 690 in FIG. 6) by posting their name to an “association” blackboard with which they publish their features publicly (block 685 in FIG. 6). Doing so results in feature sharing of known features while also (possibly) introducing new features to the society. There is no value to purely old feature sharing and so agents with identical features will leave on a last in, first out basis. Agents can also remove their name off association blackboards if they find that their utility does not evolve within these associations.

Agents join associations to satisfy their need for better performance and “fit” with respect to goals (as driven by their intents, preferences, utilities, and objective functions). Agents are directly influenced by cost. There is a cost for joining a society much like the cost to join a social club in a human society. Agents pay a fee to join the society and to have access to its services. The fees are “paid” by sharing of new features—no new features mean that there is no payment and hence, the agent would lose money in joining the society. A new agent joining a society association does so because the group of agents provides knowledge it needs and because its value increases by getting paid (virtual currency), as it could potentially partake in larger number of future bids. While in a society, each agent posts it's results on a peer-to-peer blackboard 630.

A group or society is initially defined by a single agent that took the initiative to create an association blackboard. An agent without shareable features cannot create a society. Hence, the lowest level is always the sensor or sources agent (with a limited set of usually non-shareable features). The integration of a new agent into an association is done based on the valuation of its features if associated with the society and not on the basis of the agents already belonging to it or the size of the society.

An agent does not need to know all members of a society it belongs to, only the public feature set. One “entry point” is enough to share its results with other agents and, of course, to take indirect benefit of other agents' “know-how.” The membership of an agent to a society is not necessarily a long-term contract. In the case of certain applications, it might be just the duration of a user's query.

Furthermore, either via a master agent or due to a human intervention the agent may receive feedback 640 indicative as to whether the percepts generated by the agent are useful in the society setting. Accordingly, the agents can predict their market value (based on a Black Scholes model) and respond by adjusting their parameters for obtaining data and generating a precept therefrom. Additionally, the agent may receive control messages 670 that are indicative of whether an agent should buy more hypotheses; sell its hypothesis; and the like.

In what follows, is provided by one embodiment of the present disclosure, a framework with which agents form societies followed by a detailed description of a framework that enables agents to trade hypothesis in order to evolve.

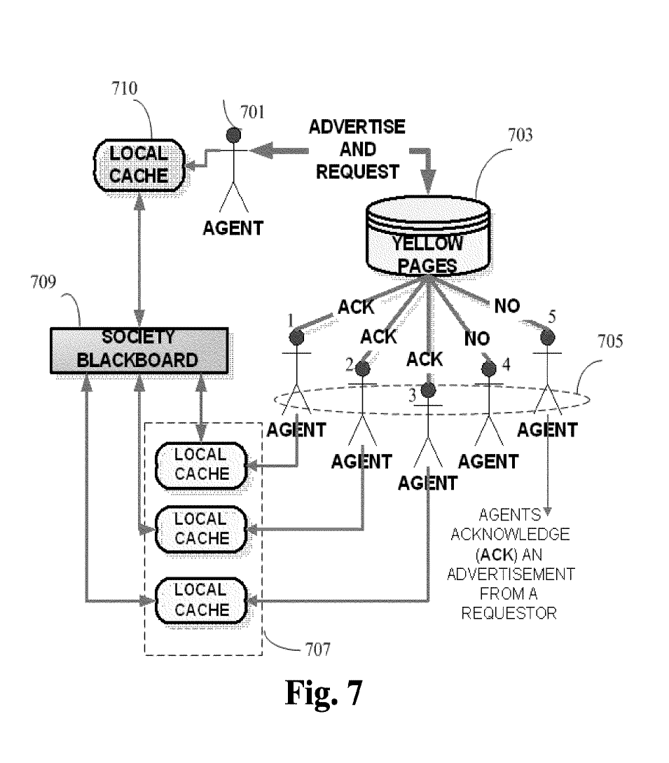

FIG. 7 illustrates according to one embodiment, communication framework between agents to form agent-societies. According to one embodiment of the present disclosure, agents communicate with one another to form societies in order to mutually assist one another in solving a particular task and thereby coexist.

Agents are aware of each other's existence by implementing a lightweight directory access protocol on a shared memory space (referred to hereinafter as a ‘blackboard’) that is used by the agents. The directory is analogous to a “yellow pages” phone book that enumerates the capabilities and addressing scheme of each agent. Thus, by using the yellow pages, an agent can ask a potential helping agent to collaborate on sub-proofs in a complex problem. When asked for such help, and if the reward (for the helping agent) is attractive enough (described later), the helping agent transmits computed abductive answers (if any) to the requesting agent, one at a time. It must be appreciated that each agent can be involved in several proofs (collaborations) at the same time as each agent launches distinct coordination message threads for handling separate proof requests.

By one embodiment, the interaction between agents may be one of a lateral interaction (i.e., interacting agents are in the same architectural layer), and a hierarchical interaction (i.e., the interacting agents are in different architectural layers). Each agent performs three important functionalities: (a) discovery and socialization using blackboard (communications) protocols; (b) handling and coordinating (social) requests; and (c) collaborative and cooperative (social) reasoning.

Referring to FIG. 7, is depicted a help requesting agent 701, a yellow pages directory 703, a pool of agents 705 (including five agents labeled 1-5), local caches 707 (each cache in 707 belonging to agents 1-3, respectively), a society blackboard 709, and a local cache 710 belonging to agent 701. The blackboard 709 is responsible for connecting the agents to a society. The society is formed by agents found using the ‘yellow pages’ directory registry 703. Each agent has its own local-blackboard cache that is used as a communications buffer to the society.

The framework as depicted in FIG. 7 supports a registration, a subscription and an advertisement message issued by the agents. When an agent receives a message from another agent requesting help, it sends its advertisements to other blackboards (if any) within the hierarchy, and if it receives an unregister message from another agent, it removes all the advertisements for that agent from its directory and other blackboards. Further, each agent automatically updates its local message pool, which may include goals, facts or data in response to advertised or unadvertised messages from other agents, whenever they are received.

As shown in FIG. 7, the help requesting agent 701 advertises itself and its requirement for help to all agents, in solving some goal. In this case, the total number of agents 705 is five (agents labeled 1-5) wherein, three agents (agents 1-3) answer with an acknowledgment and join a society blackboard 709 (setup by the requesting agent), while two others (agents 4 and 5) decline. Note that if agents do not answer (within a predetermined time-window) to a request issued by a particular agent, then the agent is considered as not participating in the society.

Furthermore, incoming requests are handled by the society blackboard 709 and by the agent's private blackboard-cache 710, in order to allow multiple reasoning tasks to run simultaneously, for each accepted incoming request and for each agent. Additionally, by one embodiment, an incoming request includes the specific goal to be proven, the identities of all agents in the current society, evidence and hypotheses. It must be appreciated that if an agent is in the current society, the request is always accepted by the agent. However, if the agent is not in the current society, and a broadcast message is received that satisfies its consistency constraints (i.e., if a truth maintenance with that agent succeeds) the request is accepted. If a new agent is directly sent a request but cannot accept the request, its sends a decline message in response to indicate that it cannot join the current society, given the current message request.

The agent, if it accepts participation in a society, will perform abductive reasoning using its internal abductive meta-interpreter to solve goals collaboratively. It sends a ready message to the society. Once it receives goals from the society it will eagerly generate any abductive answers and caches them in order of generation on a blackboard internal to the agent. Then, it waits for and services next requests from the society. On receipt, it removes the next result from its blackboard and sends it back to the society and waits to see if the answer it provided is consistent with the society. If it is not, it provides the remainder of its answers and when it has explored all proof paths, and no more answers will be found it advises the society.

Furthermore, the above described framework of FIG. 7 incurs the advantageous ability of isolating the private reasoning processes (of each agent) from the society, by using the blackboard-cache between the society and the agent as a buffer. In addition to using the yellow pages to find potential agents, by one embodiment, a particular agent may locate a society blackboard and post it's request message there, or alternatively, the agent can post to a public blackboard and wait to see if any agent responds within a given timeout period. Once the agent has found possible collaborators, it may offer to create a society for them to join (if it has sufficient funds for reward payment) or it may just cache the agents in an internal collaborator list and then conduct one-on-one communications. Furthermore, it must be appreciated that the individual agents may be located on a single core or a multi-core system. When the agents reside on a multi-core system, the system formed by the agents in collaboratively solving the problem corresponds to a cloud-based agent system.

FIG. 8 illustrates according to one embodiment, a schematic representing an execution cycle of agents. The execution cycle begins with a master clock transmitting a logical timestamp event to all agents in the system as an indication for performing a synchronous start. By one embodiment, all agents initially are in a dormant state and the “heartbeat” integer coded event (e.g., even numbers corresponding to a “start” operation and odd numbers corresponding to an “end”) from the master clock awakens them. The heartbeat event is an analog to a heart beating. Specifically, the agents use the heartbeat for internal housekeeping and also, when and as needed, for mutual synchronization.

Agents respond to the heartbeat event by moving into an active working state by posting their identity to the blackboard as active and working agents. Agents that are dead or unresponsive are killed and re-started in order to make sure that all the agents possible are actually alive. Agents may die (and eventually be restarted) for many reasons during startup, such as reasons pertaining to acquiring their heap space and stack space from the host operating environment or due to other operating systems issues.

The purpose of the master clock heartbeat is to set a time-base for the agents' “internal clocks” which serve to preserve computing resources, by limiting the amount of time that agents utilize the processor, as agents compute their efficiencies in rates of resources, pay rates and the like. By one embodiment, decreasing the period of the clock will reduce the number of dynamic changes in the inputs and the state variables. On the other hand, longer time-periods would mean that agents would over-approximate and thereby lose track of the finer details as they learn. Hence, with long time periods, the patterns are likely to be quite coarse. Accordingly, it must be appreciated that there is a tradeoff in setting the values of the master clock time-periods and moreover that different data may require different kinds of timing. Furthermore, an advantageous ability of the master-clock system is increased sensitivity to anomalies (i.e., the cause of triggering events) that causes an interruption in the agent system, and activates high intensity focus in responding to the event.

As stated previously, the AIT system of the present disclosure is built using a market model (also referred to herein as a cost model) to enable the societies of agents to self-tune their consumption of computing resources. Specifically, computing resource allocations are to be determined such that the intelligent processing activities of the agents are optimized. In such a model, agents self-tune their consumption of their natural (computing) resources towards the optimization of quality of information with respect to scale of inputs. In effect, the agents form a society, whose structure evolves to generate the best reports.

According to one embodiment of the present disclosure, a technique to relate a value of a percept in the cost model is based on the costs of resource consumption of the agent within the computer. The amount of resource consumption is related to the resource limitations of a particular hardware. Thus, in this regard, the cost model optimizes percept memory for those percepts that are most useful in the context of reasoning operations (as opposed to treating all percepts as if they were all equally important).

Referring to AIT-Algorithm-Cycle, and as previously stated, the operation cycle of the AIT continues until sufficient evidence, above a threshold value (e.g. based on a threshold determined by an analyst), triggers the generation of a report.

Initially, the system assigns each agent a starting salary (i.e., an initial startup fund, referred to herein as currency units). In such a cost system, the agents generate percepts, form societies, and the like, by spending their currency units, and in return are awarded currency units if the percept generated by the agent is useful to solve the problem under consideration. By one embodiment, the rewarding of currency units to agents that are thriving (i.e., evolving and producing feasible data) can be based on a payment scheme as outline in Table VII.

TABLE VII
payment criterion for agents.

| No. | Criterion | Currency |
|---|---|---|
| 1. | Definitions produced by Agents, i.e., feasible | 100 |
| | data/facts | |
| 2. | Concepts with no examples i.e., hypotheses formed | 200 |
| | by agents | |
| 3. | Concepts with examples | 300 |
| 4. | New Concepts | 400 |
| 5. | Conjectures made by agents | 500 |
| 6. | Explanations provided by agents | 700 |
| 7. | Axioms to support theories | 1000 |

It must be appreciated that the payment scheme as outlined in Table VII is only a non-limiting example depicting the criteria for agents to get rewarded. However, other mechanisms of determining a reward structure are well within the scope of the present disclosure. For instance, the reward amount given to an agent (as well as the startup fund) may be assigned based on factors such as capabilities, skills, quality of information generated by the agents and the like.

According to one embodiment of the present disclosure, the cost model for evaluating agents is somewhat analogous to a trading model (e.g., Santa Fe Artificial Stock Market). However, a crucial difference between the prior trading models and the cost model described herein is that in the cost model agents enter an auction whereby the agents trade hypotheses to determine if a particular agent should collaborate with another agent or enter a society of agents such that in doing so, the agent may potentially evolve and increase its assets (i.e., get rewarded in the form of currency units). Furthermore, unlike simulating for the price of a particular entity (trading asset), the cost model of the present disclosure traded hypotheses in order to utilize the price-movements of the agents to drive a pattern understanding for cognizing entities, relations, high-level concepts of interest.

By one embodiment, the agent at layer N+1 creates a view of the state of a subsystem at layer N. In other words, an upper level agent sees the lower level society of agents through its filtering activities. The auction of trading hypotheses by the agents is based on the following primitives: offering a hypothesis, retracting a hypothesis, proposing to buy hypotheses, propose to sell hypotheses, hold hypotheses and the like. Further, if a bid is retracted, then the agent cannot offer a hypothesis and thus does no get rewarded (i.e. not paid). If a bid is offered, an agent can get paid. Offers and retractions occur from lower-level societies to upper-level societies. Thus, if a lower level agent's hypotheses are consistently not bought, the agent will retract its hypotheses and try another society in order to seek a way to get paid. Note however, that ultimately, the agent may never make money if its hypotheses are constantly rejected and thus may subsequently fail to exist. In a similar manner, when agent's hypotheses are bought, the agent gets rewarded (in terms of currency units) and thus continues to evolve.

Furthermore, by one embodiment, the system could implement a basic selection algorithm to identify those agents that are useful to the mission theme and to get rid of agents whose outputs do not influence the end results produced by the system, in that they do not change the feedback (positively or negatively) when the system compares its outputs to see if it matches a training set. Further, the system can implement the above described cost model to develop the parameter sets of the chosen agents for buying/selling evidence (i.e. percepts about the data) or hypotheses that an agent may form.

In addition to above described embodiments, for each event and each possible action, the agent has a real-valued measure that controls its intention for achieving a particular state. Specifically, the intention concept is composed of preference functions, utility functions, and objective functions (guidance system 660 in FIG. 6). The agents can use a Black-Scholes model to determine their value in the system. Accordingly, in order to solve a particular problem, the agents in the system will continue to participate in the auction by trading hypotheses, joining societies of agents, and the like in order to continuously evolve. By one embodiment, the agents continue the evolving process until a state of equilibrium (e.g. Nash equilibrium) of the agents is achieved (i.e., a state where the agents are not motivated to change their current state as doing so would not further increase a positive feedback).

Each of the functions of the above described embodiments may be implemented by one or more processing circuits. The circuitry may be particularly designed or programmed to implement the above described functions and features which improve the processing of the circuitry and allow data to be processed in ways not possible by a human or even a general purpose computer lacking the features of the present embodiments. A processing circuit includes a programmed processor (for example, processor 903 in FIG. 9), as a processor includes circuitry. A processing circuit also includes devices such as an application-specific integrated circuit (ASIC) and conventional circuit components arranged to perform the recited functions. For instance, circuitry described herein (FIG. 9) can control the agents of above described embodiments is a manner such that the circuitry can efficiently make decisions determining the amount of processing resources to be allocated to the agents in an optimal fashion, thereby improving the overall functionality of the computer in solving a particular complex problem.

The various features discussed above may be implemented by a computing device such as a computer system (or programmable logic). FIG. 9 illustrates such a computer system 901. The computer system 901 of FIG. 9 may be a particular, special-purpose machine. In one embodiment, the computer system 901 is a particular, special-purpose machine when the processor 903 is programmed to compute vector contractions.

The computer system 901 includes a disk controller 906 coupled to the bus 902 to control one or more storage devices for storing information and instructions, such as a magnetic hard disk 907, and a removable media drive 908 (e.g., floppy disk drive, read-only compact disc drive, read/write compact disc drive, compact disc jukebox, tape drive, and removable magneto-optical drive). The storage devices may be added to the computer system 901 using an appropriate device interface (e.g., small computer system interface (SCSI), integrated device electronics (IDE), enhanced-IDE (E-IDE), direct memory access (DMA), or ultra-DMA).

The computer system 901 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 901 may also include a display controller 909 coupled to the bus 902 to control a display 910, for displaying information to a computer user. The computer system includes input devices, such as a keyboard 911 and a pointing device 912, for interacting with a computer user and providing information to the processor 903. The pointing device 912, for example, may be a mouse, a trackball, a finger for a touch screen sensor, or a pointing stick for communicating direction information and command selections to the processor 903 and for controlling cursor movement on the display 910.

The processor 903 executes one or more sequences of one or more instructions contained in a memory, such as the main memory 904. Such instructions may be read into the main memory 904 from another computer readable medium, such as a hard disk 907 or a removable media drive 908. One or more processors in a multi-processing arrangement may also be employed to execute the sequences of instructions contained in main memory 904. In alternative embodiments, hard-wired circuitry may be used in place of or in combination with software instructions. Thus, embodiments are not limited to any specific combination of hardware circuitry and software.

As stated above, the computer system 901 includes at least one computer readable medium or memory for holding instructions programmed according to any of the teachings of the present disclosure and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes.

Stored on any one or on a combination of computer readable media, the present disclosure includes software for controlling the computer system 901, for driving a device or devices for implementing the invention, and for enabling the computer system 901 to interact with a human user. Such software may include, but is not limited to, device drivers, operating systems, and applications software. Such computer readable media further includes the computer program product of the present disclosure for performing all or a portion (if processing is distributed) of the processing performed in implementing any portion of the invention.

The computer code devices of the present embodiments may be any interpretable or executable code mechanism, including but not limited to scripts, interpretable programs, dynamic link libraries (DLLs), Java classes, and complete executable programs. Moreover, parts of the processing of the present embodiments may be distributed for better performance, reliability, and/or cost.

The term “computer readable medium” as used herein refers to any non-transitory medium that participates in providing instructions to the processor 903 for execution. A computer readable medium may take many forms, including but not limited to, non-volatile media or volatile media. Non-volatile media includes, for example, optical, magnetic disks, and magneto-optical disks, such as the hard disk 907 or the removable media drive 908. Volatile media includes dynamic memory, such as the main memory 904. Transmission media, on the contrary, includes coaxial cables, copper wire and fiber optics, including the wires that make up the bus 902. Transmission media also may also take the form of acoustic or light waves, such as those generated during radio wave and infrared data communications.

Various forms of computer readable media may be involved in carrying out one or more sequences of one or more instructions to processor 903 for execution. For example, the instructions may initially be carried on a magnetic disk of a remote computer. The remote computer can load the instructions for implementing all or a portion of the present disclosure remotely into a dynamic memory and send the instructions over a telephone line using a modem. A modem local to the computer system 901 may receive the data on the telephone line and place the data on the bus 902. The bus 902 carries the data to the main memory 904, from which the processor 903 retrieves and executes the instructions. The instructions received by the main memory 904 may optionally be stored on storage device 907 or 908 either before or after execution by processor 903.

The computer system 901 also includes a communication interface 913 coupled to the bus 902. The communication interface 913 provides a two-way data communication coupling to a network link 914 that is connected to, for example, a local area network (LAN) 915, or to another communications network 916 such as the Internet. For example, the communication interface 913 may be a network interface card to attach to any packet switched LAN. As another example, the communication interface 913 may be an integrated services digital network (ISDN) card. Wireless links may also be implemented. In any such implementation, the communication interface 913 sends and receives electrical, electromagnetic or optical signals that carry digital data streams representing various types of information.

The network link 914 typically provides data communication through one or more networks to other data devices. For example, the network link 914 may provide a connection to another computer through a local network 915 (e.g., a LAN) or through equipment operated by a service provider, which provides communication services through a communications network 916. The local network 914 and the communications network 916 use, for example, electrical, electromagnetic, or optical signals that carry digital data streams, and the associated physical layer (e.g., CAT 5 cable, coaxial cable, optical fiber, etc.). The signals through the various networks and the signals on the network link 914 and through the communication interface 913, which carry the digital data to and from the computer system 901 may be implemented in baseband signals, or carrier wave based signals.

The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 901 can transmit and receive data, including program code, through the network(s) 915 and 916, the network link 914 and the communication interface 913. Moreover, the network link 914 may provide a connection through a LAN 915 to a mobile device 917 such as a personal digital assistant (PDA) laptop computer, or cellular telephone.

While aspects of the present disclosure have been described in conjunction with the specific embodiments thereof that are proposed as examples, alternatives, modifications, and variations to the examples may be made. Furthermore, it should be noted that, as used in the specification and the appended claims, the singular forms “a,” “an,” and “the” include plural referents unless the context clearly dictates otherwise.

1. A method implemented by processing circuitry configured to execute intelligent software agents, the method comprising:
tasking the software agents with a specific goal;
providing relevant evidential signal schemata and related measures to a pool of agents from the database management system (DBMS), which is a collective memory that includes agents, algorithms, and schemata;
synthesizing a pool of hypothesis by using an economic evolution process by combining background knowledge, which includes heuristics;
revising the pool of hypotheses by trading evidence and hypotheses, and auctioning off results;
forming a prediction score for each hypothesis in the pool of hypothesis; and
when the prediction score is profitable, generating a report and outputting the report to the user and when the prediction score is not profitable, executing a search for more data to confirm or disconfirm the respective hypotheses.
